(19) United States
(12) Patent Application Publication
(10) Pub. No.: US 2001/0016456 A1
(43) Pub. Date: Aug. 23, 2001

(54) Cable connector for a shielded cable

(75) Inventor: Albertus Van Zanten, DP's-Hertogenbosch (NL)

Correspondence Address: Clarence A. Green, PERMAN & GREEN, LLP, 425 Post Road, Fairfield, CT, 06430, US

(73) Assignee: Framatome Connectors International

(21) Appl. No.: 09/754,798

(22) Filed: Jan. 4, 2001

(30) Foreign Application Priority Data
Jan. 7, 2000 (NL) NL 1014035

(51) Int. Cl. H01R 13/60

(52) U.S. Cl. 439/680; 439/540.1; 439/701

(57) ABSTRACT

The invention pertains to a connector for at least one cable with one or more conductors, comprising at least one housing of an electrically insulating material containing contact elements that are connected or to be connected to the conductors. The connector comprises a hood, which at least partially accommodates the housing and which comprises at least a passage for at least one cable, means for connecting the hood to a support panel for a printed circuit board, cable or the like, and one or more coding protrusions on the side that, upon connection to the support panel that is provided with holes for receiving corresponding coding protrusions, faces the support panel.

The invention pertains to a connector for a cable with one or more conductors, comprising at least one housing of an electrically insulating material containing contact elements that are connected or to be connected to the conductors.

Connectors of this kind are known, for example from EP 0 907 221, and are, for instance, marketed by FCI Electronics as round cable connectors of the Metral™ system. Connectors of this kind are usually intended for connection to a counterpart, e.g. a header if the connector is a receptacle and vice versa, that is attached to a printed circuit board or to the end of another cable. Thus, forces exerted on the cable connector are transmitted to the said counterpart and consequently to respectively the printed circuit board or the other cable. The said printed circuit boards or cables are often mounted in a frame, e.g. the frame of a telephone exchange device. Such a frame can be shielded itself so as to provide a Faraday cage or can be mounted in a suitable shielded casing. The frame comprises a support panel, which in case of a shielded frame is also referred to as a front panel, which comprises one or more openings through which one or more cable connectors can be connected to their counterparts.

The invention aims to provide a connector for a cable of the above mentioned type, wherein the transmission of forces exerted on the cable connector to its counterpart is obviated or at least reduced considerably.

To this end, the connector according to the invention is characterized in that the connector comprises a hood, which at least partially accommodates the housing and which comprises at least a passage for at least one cable, means for connecting the hood to a support panel for a printed circuit board, cable or the like, and one or more coding protrusions on the side that, upon connection to the support panel, faces the support panel and wherein the front panel is provided with holes for receiving corresponding coding protrusions.

Forces exerted on the connector according to the present invention are transmitted through the hood to the said support panel, whereas the transmission of forces to the printed circuit board, cable or the like is avoided or at least reduced considerably. Further, the coding protrusions can be located at specific positions corresponding to specific holes in the front panel. Thus, the chance of establishing incorrect connections through a mix-up of connectors is avoided or at least reduced.

It is preferred that the hood accommodates two or more housings, each housing being provided with contact elements that are connected or to be connected to the conductors in their respective cables. Many cable connectors are available in a limited number of so-called position modules. For instance, the above mentioned cable connector according to the Metral™ system is available in 5×1, 5×2, 5×4, 5×6 and 5×8 position modules. By using a hood that accommodates two or more of these position modules, a large number of different connectors can be assembled using connector elements that are already available.

It is further preferred that, if the conductors comprised in the cable are provided with a common shielding, the hood is shielded, for instance by using a hood which is made of a metal or a metallized plastic. By using a shielded hood, the connector according to the present invention is rendered front mountable. For instance, instead of using the connectors inside the shielded casing of a shielded telephone exchange device, the said connectors can now be connected directly to the front panel of the said device. Using a shielded hood also renders the connector more suitable for use in applications that are sensitive to Electro Magnetic Interference or EMI, such as devices operating a high signal transfer rates.

The invention will be further explained by reference to the drawings in which an embodiment of the connector according to the present invention is schematically shown.

FIG. 1 shows a standard shielded connector for a cable.

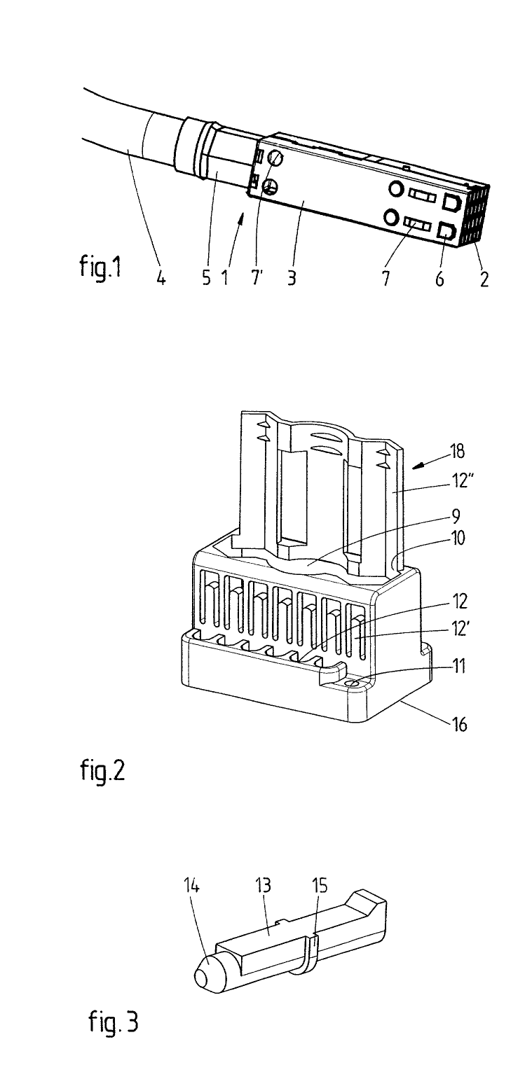

FIG. 2 shows a hood that can be slided over standard shielded connectors.

FIG. 3 shows a coding pin for use in the hood according to FIG. 2.

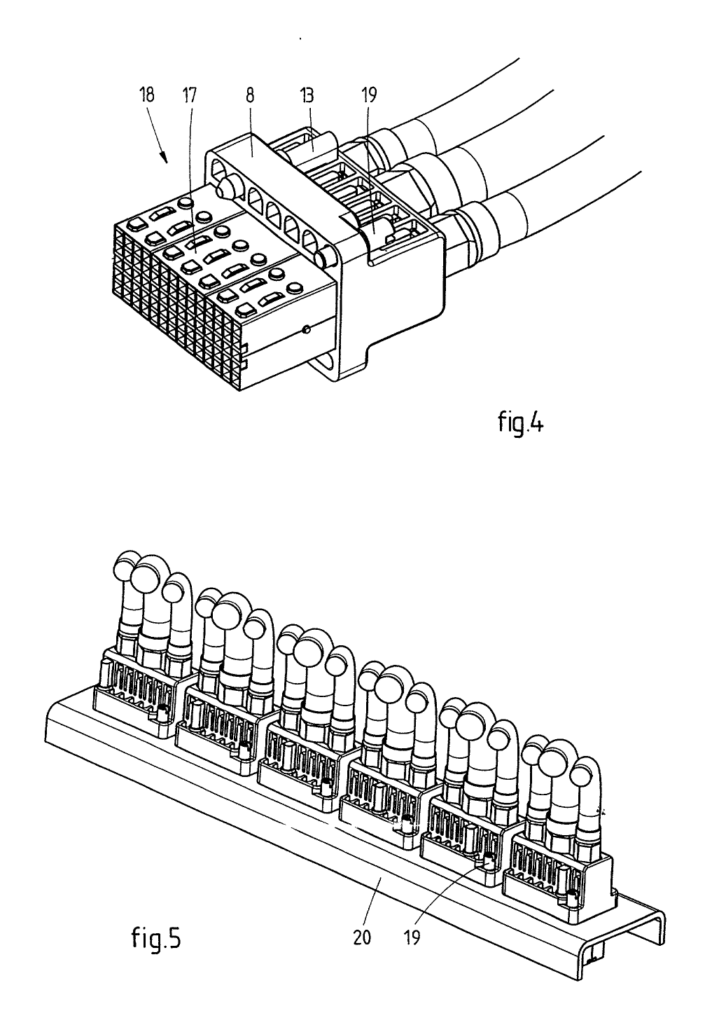

FIG. 4 shows the hood of FIG. 2 which now accommodates three standard connectors.

FIG. 5 shows six composite connectors according to the present invention whilst attached to a front panel.

FIG. 1 shows a shielded round cable connector 1, in this case a receptacle, comprising a housing 2 consisting of multiple terminal blocks each of which has a minimum of 5×1 positions and, accordingly, comprises a minimum of 5×1 contact elements. The housing 2 is surrounded and held together by a metal shield 3. The contact elements are connected to conductors (twenty in all) in cable 4. The metal shield 3 is electrically connected to the shielding of the cable 4 by means of an inner ferrule and a shrink ring 5. Polarising ribs 6 on the housing 2 and springs 7 on the metal shield 3 serve to align the connector 1 with a header that is connected to a printed circuit board, cable or the like. Polarising ribs 6 and springs 7 may serve as contacts to support the grounding of the shield 3.

FIG. 2 shows a hood 8 in accordance with the present invention. This particular hood 8 comprises a cavity 9 for accommodating one or more connectors. The hood 8 can be manufactured by means of injection moulding a thermoplastic material. The hood 8 can be provided with an electrically conductive metal coating (not shown). Such coatings are known to the person skilled in the art, and may, for instance, comprise a copper layer with a thickness of say 1-2μ on which a nickel or aluminium of say 2-3μ has been deposited.

To ensure that effective electrical contact is established between the shield of the connectors and the shield of the hood 8, the cavity 9 of the hood 8 is undersized with respect to the connectors which are to be placed therein. The hood 8 comprises a passage 10 for the cables of the connectors. Hood 8 further comprises two diametrically opposed holes 11 for fastening screws. Other fastening means can, of course, be used, e.g. latches or resilient protrusions allowing a snap-fit connection.

The side of the hood 8 which, upon connection to a printed circuit board, cable or the like, abuts the front panel of a frame for supporting such a printed circuit board, a cable or the like, is substantially rectangular. Six openings 12 are provided along one of the long sides of this rectangle for housing a coding means.

The hood 8 further comprises latches 12′, which, upon placing a connector 1 into the cavity 9, establish a snap-fit connection with latch-holes 7′ that are provided in the shield 3 of the connector 1.

Also, a wall 12″ extends from the hood 8, which, again upon placing one ore more connectors in the cavity 9, supports the respective cables and limits the bending of the cables near the actual connectors. Thus, the wall 12″ provides a strain relief for each of the connectors placed in the cavity 9.

FIG. 3 shows a suitable example of a coding means, viz. coding pin 13, which comprises, on one of its ends, a protrusion 14 and a stop 15 which upon insertion of the coding pin 13 in one of the openings 12 abuts the edge of this opening and ensures that the protrusion 14 extends over a predetermined distance below the lower surface of the hood 8. By using one or more of the coding pins 13, the shape of the lower surface 16 of the hood 8 can be tailored to fit corresponding openings or recesses in the front plate of the mentioned frame.

FIG. 4 shows the hood 8 of FIG. 2 which has now been slided over two 4×5 connectors 1 (as shown in FIG. 1) on the left hand and right hand side and a 6×5 connector 17 in the middle, thus obtaining a non-standard 14×5 connector 18.

FIG. 5 shows six of the connectors 18 as shown in FIG. 4 attached by means of fastening screws 19 to a front panel 20. Each of the connectors 18 comprises a single coding pin 13 placed in a different hole for each of the connectors 18. Corresponding holes are provided in the front panel 20 thus making sure that the connectors 18 are not interchangeable.

From FIG. 5 it will be clear that forces exerted on the cables extending through the passages 10 of the connectors 18 will be transmitted to the edge of the passages 10 and not to the headers and the printed circuit boards, cables or the like, to which these headers are attached. The said forces will be transmitted through the hoods to the front panel 20.

A further advantage of the connector according to the present invention resides in that connectors comprising a non-standard number of positions can be assembled efficiently and at will, especially if the individual connectors are end-to-end stackable.

If the hood is shielded, the connectors according to the invention can be front mounted on a frame or casing of e.g. a telephone exchange device. A further advantage of the connector according to the invention resides in that connectors comprising a large number of positions do not have a single, rigid cable comprising the same number of conductors but, instead, comprise a number of more flexible cables comprising a lesser number of conductors.

It should be noted that instead of attaching protrusions or coding pins to the hood and providing recesses in the front panel, it is also possible to provide protrusions or coding pins on the front panel and provide corresponding recesses in the hood.

The invention is not restricted to the above described embodiment which can be varied in a number of ways within the scope of the invention.

1. Connector (1; 18) for at least one cable (4) with one or more conductors, comprising at least one housing (2) of an electrically insulating material containing contact elements that are connected or to be connected to the conductors, characterized in that the connector (18) comprises a hood (8), which at least partially accommodates the housing (2) and which comprises at least a passage (10) for at least one cable (4), means for connecting the hood (8) to a support panel (20) for a printed circuit board, cable or the like, and one or more coding protrusions (14) on the side that, upon connection to the support panel (20), faces the support panel (20) and wherein the front panel (20) is provided with holes for receiving corresponding coding protrusions.

2. Connector according to claim 1, wherein the hood (8) accommodates two or more housings (2) of an electrically insulating material, each housing (2) being provided with contact elements that are connected or to be connected to the conductors in their respective cables (4), and comprises one of more passages (10) for the cables (4).

3. Connector according to claim 1 or 2, wherein the conductors in the cable (4) comprise a common shielding and wherein the connector further comprises a shielding (3) in which the housing (2) is fitted and that is connected or to be connected to the shielding of the cable (4).

4. Connector according to any one of the preceding claims, wherein the hood (8) is shielded.

5. Connector according to claim 5, wherein the hood (8) is made of a metal or a metallized plastic.

6. Connector according to claim 4 or 5, wherein the hood (8) is undersized with respect to the one or more of the shieldings (3) of the housings (2) of an electrically insulating material.

7. Connector according to any one of the preceding claims, wherein the hood comprises two or more openings (12) and at least one removable element (13) comprising a coding protrusion (14) which element (13) is placed in one of the openings (12).

8. Hood (8) for use in a connector (18) according to any one of the preceding claims, comprising a cavity (9) for at least partially accommodating the housing (2) of a connector (1), a passage (10) for a cable (4) connected to the connector (1) and means (11) for connecting the hood (8) to a support panel (20) for a printed circuit board, cable or the like.

9. Hood (8) according to claim 8, which comprises two or more openings (12) for receiving an element (13) comprising a coding protrusion (14).

10. Hood according to any one of the preceding claims, wherein the wall of the hood (8) near at least one passage (10) extends into a strain relief for the respective cable.
